(19) United States
(12) Patent Application Publication
(10) Pub. No.: US 2022/0017323 A1
(43) Pub. Date: Jan. 20, 2022

(54) SHEET PROCESSING APPARATUS AND IMAGE FORMING SYSTEM

(71) Applicant: Keisuke SUGIYAMA, Kanagawa (JP)

(72) Inventor: Keisuke SUGIYAMA, Kanagawa (JP)

(73) Assignee: Ricoh Company, Ltd., Tokyo (JP)

(21) Appl. No.: 17/372,874

(22) Filed: Jul. 12, 2021

(30) Foreign Application Priority Data
Jul. 15, 2020 (JP) 2020-121385

(51) Int. Cl. B65H 43/00; B65H 37/06; B65H 35/00

(52) U.S. Cl. CPC B65H 43/00; B65H 35/008; B65H 37/06

(57) ABSTRACT

A sheet processing apparatus includes a conveyor, a processing tool, a processing-tool contact-and-separation device, a processing-tool moving device, and a processing-tool facing device. The conveyor conveys a sheet. The processing tool processes the sheet. The processing-tool contact-and-separation device brings the processing tool into contact with the sheet and separates the processing tool from the sheet. The processing-tool moving device moves the processing tool in an intersecting direction intersecting a conveyance direction of the sheet. The processing-tool facing device faces the processing tool with the sheet interposed between the processing-tool facing device and the processing tool. The processing-tool contact-and-separation device includes a regulating member configured to regulate movement of the sheet in a different direction from both the conveyance direction and the intersecting direction.

### CROSS-REFERENCE TO RELATED APPLICATION

This patent application is based on and claims priority pursuant to 35 U.S.C. § 119(a) to Japanese Patent Application No. 2020-121385, filed on Jul. 15, 2020, in the Japan Patent Office, the entire disclosure of which is hereby incorporated by reference herein.

### BACKGROUND

### Technical Field

Embodiments of the present disclosure relate to a sheet processing apparatus and an image forming system including the sheet processing apparatus.

### Related Art

Sheet processing apparatuses are known to perform processing such as cutting or creasing on a sheet. Such a sheet processing apparatus is used to create, for example, a sticker, a card, or an unfolded form of a box-shaped three-dimensional object, from a sheet on which an image or design pattern is printed.

There are a plurality of types of sheet processing apparatuses. For example, there is a flood head type in which two-dimensional processing is performed by selectively pressing and separating a processing tool against and from a sheet fixed to a table surface while two-dimensionally moving the processing tool. Further, there is known a sheet conveyance type in which two-dimensional processing is performed by operating a processing tool while conveying a sheet.

A sheet processing apparatus of a sheet conveyance type simultaneously performs conveyance control for reciprocating a sheet in a conveyance direction and control for one-dimensionally moving a processing tool in a direction orthogonal to the conveyance direction. Then, while the processing tool is two-dimensionally moved relative to the sheet, the processing tool is selectively pressed against and separated from the sheet to perform sheet processing.

### SUMMARY

In an embodiment of the present disclosure, there is provided a sheet processing apparatus that includes a conveyor, a processing tool, a processing-tool contact-and-separation device, a processing-tool moving device, and a processing-tool facing device. The conveyor conveys a sheet. The processing tool processes the sheet. The processing-tool contact-and-separation device brings the processing tool into contact with the sheet and separates the processing tool from the sheet. The processing-tool moving device moves the processing tool in an intersecting direction intersecting a conveyance direction of the sheet. The processing-tool facing device faces the processing tool with the sheet interposed between the processing-tool facing device and the processing tool. The processing-tool contact-and-separation device includes a regulating member configured to regulate movement of the sheet in a different direction from both the conveyance direction and the intersecting direction.

In another embodiment of the present disclosure, there is provided an image forming system that includes an image forming apparatus and the sheet processing apparatus. The image forming apparatus forms an image. The sheet processing apparatus processes a sheet on which the image is formed.

### BRIEF DESCRIPTION OF THE DRAWINGS

The aforementioned and other aspects, features, and advantages of the present disclosure would be better understood by reference to the following detailed description when considered in connection with the accompanying drawings, wherein:

FIG. 1 is a perspective view illustrating a sheet processing apparatus according to an embodiment of the present disclosure;

FIG. 2 is a cross-sectional view illustrating the sheet processing apparatus;

FIG. 3 is a perspective view illustrating a main part of the sheet processing apparatus;

FIG. 4 is an enlarged side view illustrating a part of the main part of the sheet processing apparatus;

FIG. 5 is an enlarged plan view illustrating a part of the main part of the sheet processing apparatus;

FIG. 6 is an enlarged perspective view illustrating a part of the main part of the sheet processing apparatus;

FIG. 7 is a side view of a main part of the internal structure of a sheet processing apparatus according to a first embodiment of the present disclosure;

FIG. 8 is a partial front view of the main part of the internal structure of the sheet processing apparatus according to the first embodiment of the present disclosure;

FIG. 9 is a side view illustrating an operation example of the main part of the internal structure of the sheet processing apparatus according to the first embodiment of the present disclosure;

FIG. 10 is a side view illustrating an operation example of the main part of the internal structure of the sheet processing apparatus according to the first embodiment of the present disclosure;

FIG. 11 is a side view illustrating an operation example of the main part of the internal structure of the sheet processing apparatus according to the first embodiment of the present disclosure;

FIG. 12 is a side view of a main part of the internal structure of a sheet processing apparatus according to a second embodiment of the present disclosure;

FIG. 13 is a side view of a main part of the internal structure of a sheet processing apparatus according to a third embodiment of the present disclosure;

FIG. 14 is a side view of a main part of the internal structure of a sheet processing apparatus according to a fourth embodiment of the present disclosure;

FIG. 15 is a partial front view of a main part of the internal structure of a sheet processing apparatus according to a fourth embodiment of the present disclosure;

FIG. 16 is a diagram illustrating an operation display unit provided in a sheet processing apparatus, according to an embodiment of the present disclosure;

FIG. 17 is a block diagram illustrating a control configuration of a sheet processing apparatus, according to an embodiment of the present disclosure;

FIG. 18 is a functional block diagram illustrating a functional configuration of the sheet processing apparatus;

FIG. 19 is an enlarged side view illustrating a part of a processing tool provided in a sheet processing apparatus, according to an embodiment of the present disclosure;

FIG. 20 is an enlarged side view illustrating a part of another processing tool provided in the sheet processing apparatus; and

FIG. 21 is a side view illustrating an image forming system according to an embodiment of the present disclosure.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve similar results.

Although the embodiments are described with technical limitations with reference to the attached drawings, such description is not intended to limit the scope of the disclosure and all of the components or elements described in the embodiments of this disclosure are not necessarily indispensable.

Referring now to the drawings, embodiments of the present disclosure are described below. In the drawings for explaining the following embodiments, the same reference codes are allocated to elements (members or components) having the same function or shape and redundant descriptions thereof are omitted below

Overall Configuration of Sheet Processing Apparatus.

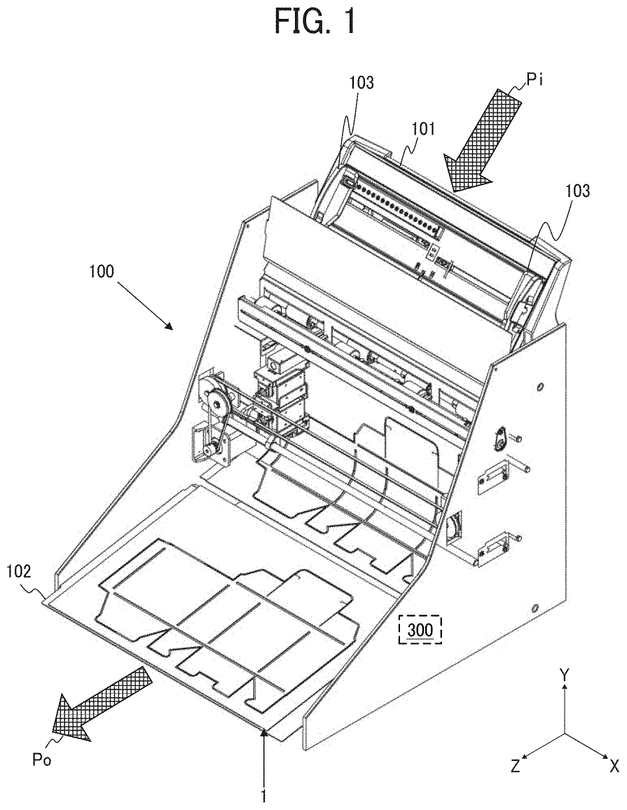

Hereinafter, embodiments of a sheet processing apparatus according to the present embodiment is described with reference to the drawings. FIG. 1 is a perspective view of the external appearance of a sheet processing apparatus 100 according to an embodiment of the present disclosure. As illustrated in FIG. 1, the sheet processing apparatus 100 includes a sheet receiver tray 101 and a sheet transfer tray 102. The sheet receiver tray 101 serves as a sheet receiving port via which a sheet 1 that functions as a sheet-shaped processing target object (sheet medium) is conveyed to the sheet processing apparatus 100. The sheet transfer tray 102 serves as a sheet transfer port of the processed sheet 1 after processing. Note that, as illustrated in FIG. 1, the sheet processing apparatus 100 further includes a control device 300 that controls the entire operations of the sheet processing apparatus 100.

Here, a description is given of a coordinate system commonly used in the following description. The following coordinate system will be referred to in the description of a conveyance direction (moving direction) of the sheet 1 and the moving direction of a processing tool in the description of embodiments of the present disclosure. A Y direction is a direction in which the sheet 1 before processing is conveyed to the sheet processing apparatus 100 and the sheet 1 after processing is conveyed from the sheet processing apparatus 100. An X direction is a direction that intersects the Y direction and a direction along a surface of the sheet 1 (the width direction of the sheet 1). The X direction also corresponds to the width direction of the sheet processing apparatus 100. A Z direction is a direction that intersects the Y direction and the X direction and corresponds to the depth direction of the sheet processing apparatus 100. The present embodiment is described based on an example in which the X direction, the Y direction, and the Z direction are orthogonal to each other.

In the present embodiment, as illustrated in FIG. 1, the direction in which the sheet 1 being processed is conveyed is the “Y direction” corresponding to the normal direction (vertical direction) with respect to a placement surface of the sheet processing apparatus 100. Accordingly, the sheet 1 being processed is reciprocated in the Y direction. That is, both of a carry-in direction of the sheet 1 and the conveyance direction at the time of sheet processing are perpendicular to a placement surface of the sheet 1. Accordingly, the dimension of the sheet processing apparatus 100 in the depth direction (Z direction) can be reduced, thus allowing the sheet processing apparatus 100 to be downsized.

The carry-in direction of the sheet 1 and the conveyance direction during sheet processing can be inclined to the horizontal direction rather than the vertical direction. Even with a configuration in which the carry-in direction of the sheet 1 and the conveyance direction of the sheet 1 during sheet processing are inclined with respect to the placement surface of the sheet processing apparatus 100, the dimension of the sheet processing apparatus 100 in the depth direction (Z direction) can also be reduced. In other words, the sheet processing apparatus 100 can also be reduced in size by adopting a configuration in which the carry-in direction and the conveyance direction of the sheet 1 are inclined with respect to the vertical direction. The effect of reducing the size of the sheet processing apparatus 100 increases as the degree of inclination (inclination angle) approaches vertical. In the case of a configuration in which the sheet 1 is carried in and conveyed from the inclined direction, the inclination angle of the carry-in path is preferably 45 degrees or more from the horizontal direction.

When the sheet processing is performed on sheets 1, as illustrated in FIG. 1, a sheet bundle is set on the sheet receiver tray 101 constituting a sheet receiving port of the sheets 1. Thus, the sheets 1 are separated one by one in a direction indicated by arrow Pi and conveyed into the sheet processing apparatus 100. Further, the processed sheet 1 is discharged in a direction indicated by arrow Po in the sheet transfer tray 102 constituting the sheet transfer port. It is desirable for the user to have easier access to the sheet receiver tray 101 and the sheet transfer tray 102. In this respect, the downsizing of the sheet processing apparatus 100 in the depth direction (Z direction) is particularly desirable from the viewpoint of enhancing user convenience.

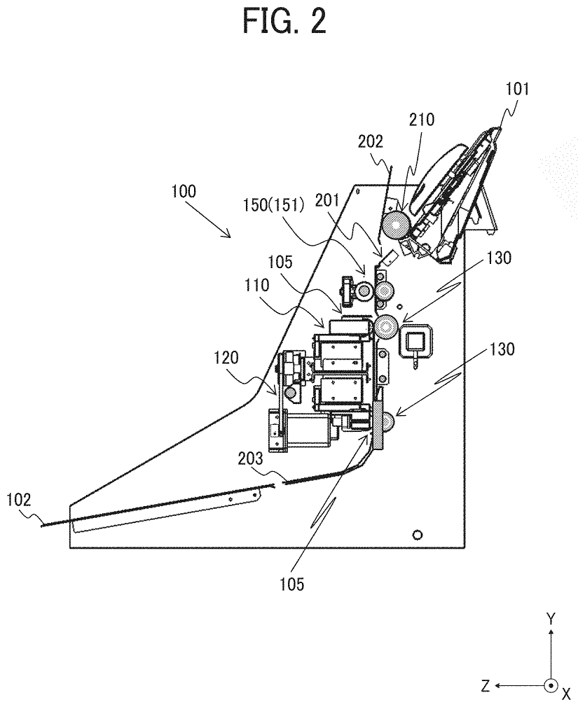

FIG. 2 is a cross-sectional view illustrating the internal configuration of the sheet processing apparatus 100. The cross-sectional view of FIG. 2 illustrates a cross-section with respect to the Y-Z plane in FIG. 1. As illustrated in FIG. 2, the sheet processing apparatus 100 includes a sheet processing tool 105 as a processing tool, a processing-tool operating device 110 as a processing-tool contact-and-separation device, a tool moving device 120 as a processing-tool moving device, and a tool facing device 130 as a processing-tool facing unit. The sheet processing apparatus 100 further includes pairs of conveyance rollers 150 that function as conveyance members to reciprocally convey the sheet 1 toward the sheet processing tools 105. The pairs of conveyance rollers 150 include a first pair of conveyance rollers 151 and a second pair of conveyance rollers 152. The pairs of conveyance rollers 150 are disposed on the sheet receiving side and the sheet transfer side of the sheet processing apparatus 100. In FIG. 2, the first pair of conveyance rollers 151 alone is depicted from the pairs of conveyance rollers 150. The first pair of conveyance rollers 151 is disposed on the sheet receiving port side.

The sheet processing tool 105 is held by the processing-tool operating device 110 and disposed at a position (facing position) facing the tool facing device 130 across the sheet 1.

The processing-tool operating device 110 bolds a sheet processing tool 105 that is a “cutter” as a cutting tool to perform cutting on the sheet 1 or a “creaser” as a creasing tool to perform creasing on the sheet 1. Details of the sheet processing tool 105 will be described later. The processing-tool operating device 110 causes the sheet processing tool 105 to execute a “press-contact operation” of bringing the sheet processing tool 105 into contact with the sheet 1. The processing-tool operating device 110 also executes a “separating operation” of separating the sheet processing tool 105 from the sheet 1. The “press-contact operation” and the “separating operation” are performed by a processing-operation mechanism included in the processing-tool operating device 110.

In the “press-contact operation” and the “separating operation”, the sheet processing tool 105 moves relative to the sheet 1 in the Z direction. The movement of the sheet processing tool 105 is performed by the processing-operation mechanism. When the sheet processing tool 105 comes into contact with the sheet 1 in the press-contact operation, the sheet processing tool 105 is at a “processing position”. When the sheet processing tool 105 is separated from the sheet 1 in the separating operation, the sheet processing tool 105 is at the “retreat position”.

The tool moving device 120 includes a tool moving mechanism that reciprocates the sheet processing tool 105 in the X direction when sheet processing such as cutting or creasing is performed on the sheet 1. Note that, in the present embodiment, the X direction is a direction orthogonal to the Y direction that is the conveyance direction of the sheet 1, in other words, an orthogonal direction to the Y direction (the conveyance direction of the sheet 1).

The tool facing device 130 has a facing surface facing the sheet processing tool 105 and includes a roller-shaped member as a rotating member that rotates. The facing surface corresponds to a processing position at which the sheet processing tool 105 moving in the X direction during processing contacts the sheet 1 and corresponds to a position at which, for example, a pressing force applied by the sheet processing tool 105 is applied to the sheet 1. The facing surface is a portion corresponding to a facing position facing the processing tool across the sheet 1.

As illustrated in FIG. 2, the facing surface of the tool facing device 130 corresponds to the same position as the position of the sheet processing tool 105 in the Y direction. In other words, the facing surface of the tool facing device 130 is disposed in the movement direction (Z direction) of the processing tool. In other words, the sheet processing tools 105 are disposed at positions facing each other across the sheet 1 in the movement direction (Z direction) of the facing surface, and are held by a configuration in which the sheet processing tools 105 does not move in the Y direction.

The sheet processing apparatus 100 executes sheet processing by the sheet processing tool 105 while conveying the sheet 1 in the Y direction. During the sheet processing, the sheet processing tool 105 and the processing-tool operating device 110 do not move in the V direction with respect to the tool facing device 130 but move in the X direction. While moving in the X direction, the sheet processing tool 105 and the processing-tool operating device 110 selectively perform contact operation and separating operation of the sheet processing tool 105 with respect to the sheet 1 while moving in the X direction. With the operation as described above, the sheet processing apparatus 100 can perform processing while drawing a locus composed of a straight line or an arbitrary plane free curve on the sheet 1.

When a sheet feeding operation is started, a sheet bundle set on the sheet receiver tray 101 is taken into the sheet processing apparatus 100 by a pickup roller, and at the same time, is separated one by one by a separation pad facing the pickup roller. The separated and conveyed sheet 1 passes through a branch claw 201 and is conveyed to the first pair of conveyance rollers 151 disposed on the sheet receiving port side. In the present embodiment, the sheet separation is performed by such a pad separation method. However, the present disclosure is not limited thereto, and for example, a belt separation method or an FRR separation method may be used. When the conveyed sheet 1 is conveyed until the rear end of the sheet 1 passes through the branch claw 201, the branch claw 201 is moved toward a switchback 202. The sheet 1 to be processed while reciprocating is processed while a part of the sheet 1 is put in and out of the switchback 202.

On the downstream side of the tool facing device 130, the sheet 1 is conveyed to the sheet transfer tray 102 while being curved along a curved conveyance guide plate 203.

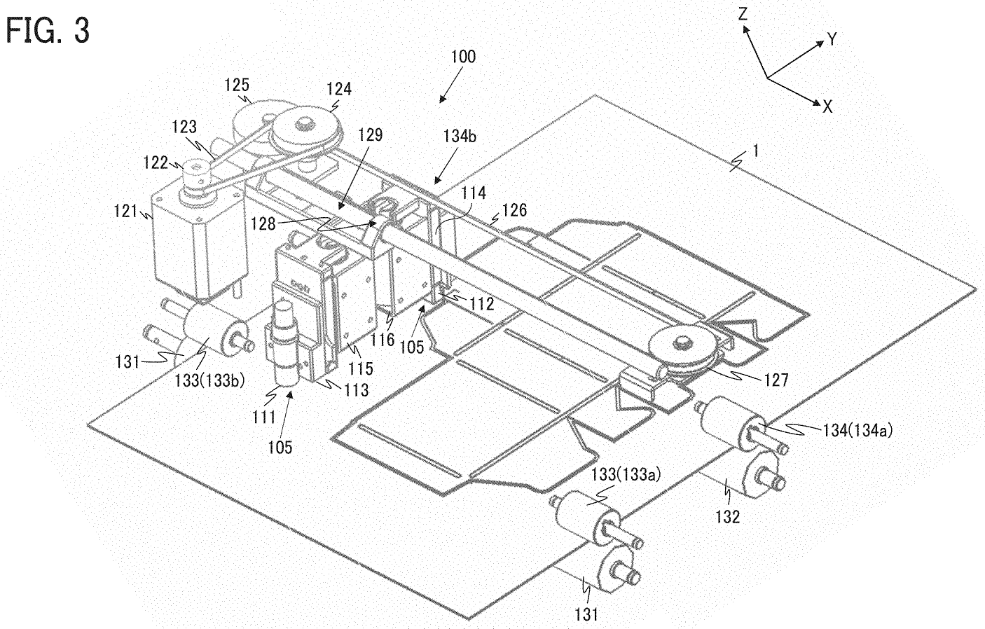

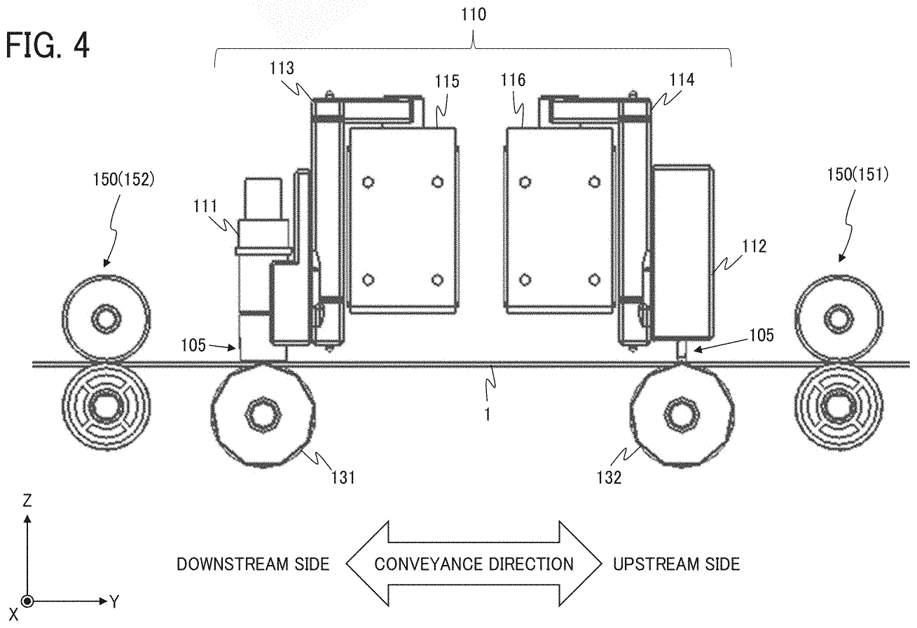

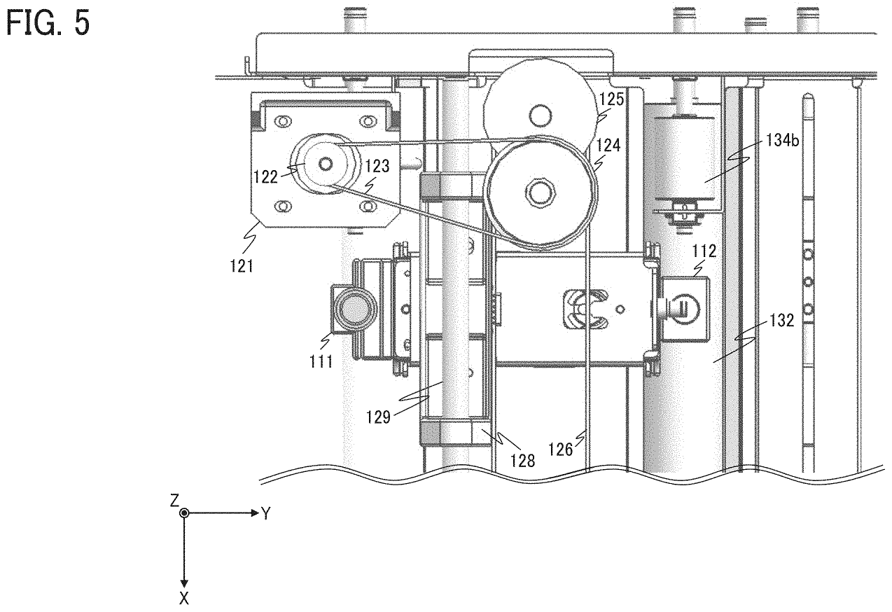

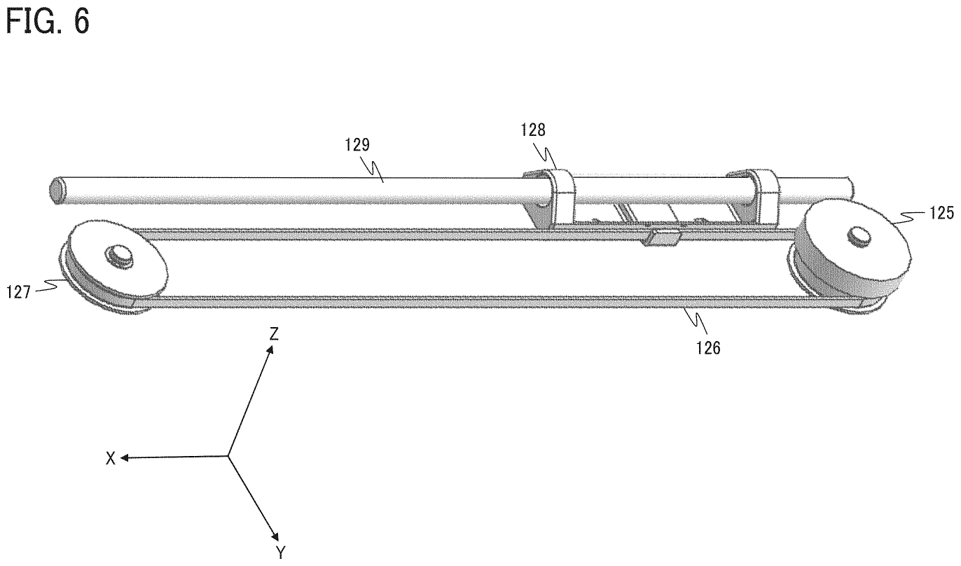

Configuration of Main Part of Sheet Processing Apparatus 100 FIG. 3 is a perspective view illustrating a main part of the internal configuration of the sheet processing apparatus 100. FIG. 4 is a side view of the sheet processing tool 105 and the processing-tool operating device 110 in the internal structure of the sheet processing apparatus 100. FIG. 5 is an enlarged plan view of a drive source portion of the tool moving device 120. FIG. 6 is an enlarged perspective view of a movement holding mechanism portion included in the tool moving device 120.

Structure of Processing-Tool Operation Device 110

First, with reference to FIGS. 3 and 4, a basic configuration of the processing-tool operating device 110 is described with reference to FIGS. 3 and 4. The processing-tool operating device 110 includes a sheet movement regulator 170 that regulates an unintended change of the sheet 1 during processing. Here, the basic operation and the like of the processing-tool operating device 110 will be described, and the detailed description of the structure, the operation, and the like of a sheet movement regulator 170 will be described later.

The processing-tool operating device 110 basically includes a cutting tool 111 and a creasing tool 112 constituting the sheet processing tool 105, a first tool holder 113, a second tool holder 114, a first contact-and-separation actuator 115, and a second contact-and-separation actuator 116.

The cutting tool 111 serving as the first processing tool is a cutting tool that comes into contact with the sheet 1 to cut the sheet 1. The creasing tool 112 that serves as a second processing tool is a creaser that presses the sheet 1 to crease the sheet 1, in other words, to make a crease line or lines in the surface of the sheet 1. The cutting tool 111 is retained above a first facing roller 131 in the vertical direction (Z direction). The cutting tool 111 that serves as a tool facing body is disposed facing the first facing roller 131. The creasing tool 112 is retained above a second facing roller 132 in the vertical direction (Z direction). The creasing tool 112 that serves as a tool facing body is disposed facing the second facing roller 132.

The first tool holder 113 couples and holds the first contact-and-separation actuator 115 and the cutting tool 111. The second tool holder 114 couples and retains the second contact-and-separation actuator 116 and the creasing tool 112.

The first contact-and-separation actuator 115 and the second contact-and-separation actuator 116 are coupled with each other by a processing-tool moving member 128. Details of the processing-tool moving member 128 are described below. The processing-tool moving member 128 causes the processing-tool operating device 110 to hold the sheet processing tool 105 (the cutting tool 111 and the creasing tool 112) so that the cutting tool 111 and the creasing tool 112 movable as a single unit in the X direction. The first contact-and-separation actuator 115 and the second contact-and-separation actuator 116 are solenoids. By supplying the power to the first contact-and-separation actuator 115 and the second contact-and-separation actuator 116, the sheet processing tools 105 maintain in a pressing state in which the first facing roller 131 and the second facing roller 132 press the sheet 1. Therefore, by controlling the operations of the first contact-and-separation actuator 115 and the second contact-and-separation actuator 116, the cutting tool 111 and the creasing tool 112 are controlled to selectively contact to or separate from the sheet 1. This contact and separation control controls the processing operation to the sheet 1.

As illustrated in FIG. 4, the first pair of conveyance rollers 151 that serves as a conveyor is disposed upstream from the processing-tool operating device 110 that retains the sheet processing tools 105, in the Y direction (i.e., the conveyance direction of the sheet 1). The second pair of conveyance rollers 152 that serves as a conveyor is disposed downstream from the processing-tool operating device 110 that retains the sheet processing tools 105, in the Y direction. The sheet 1 is conveyed in the Y direction by the pairs of conveyance rollers 150 (including the first pair of conveyance rollers 151 and the second pair of conveyance rollers 152). After having been conveyed from the upstream side in the Y direction to the sheet processing apparatus 100, the sheet 1 is held by the first pair of conveyance rollers 151. Due to rotation of the first pair of conveyance rollers 151, the sheet 1 is conveyed under the sheet processing tools 105 to be processed. After the sheet processing is performed to the sheet 1, the sheet 1 is held by the second pair of conveyance rollers 152 to be conveyed out from the sheet processing apparatus 100.

As illustrated in FIG. 3, the first facing roller 131 is disposed facing each first gripping roller 133 that rotates along with rotation of the first facing roller 131. To be more specific, one first gripping roller 133 (that is, a first gripping roller 133a) is disposed facing the first facing roller 131 on one end side of the first facing roller 131 in the X direction and another first gripping roller 133 (that is, a first gripping roller 133b) is disposed facing the first facing roller 131 on the opposite end side of the first facing roller 131 in the X direction. The second facing roller 132 is disposed facing a second gripping roller 134 that rotates along with rotation of the second facing roller 132. The sheet 1 is reciprocally moved (conveyed) in the Y direction with the sheet 1 being gripped by the first facing roller 131 and the first gripping rollers 133 and by the second facing roller 132 and the second gripping rollers 134.

Structure of Tool Moving Device 120

Next, the configuration of the tool moving device 120 will be described with reference to FIGS. 3, 5, and 6. The tool moving device 120 includes an X-axis drive motor 121, an output timing pulley 122, a first timing belt 123, a deceleration timing pulley 124, a first processing-tool moving pulley 125, a second timing belt 126, a second processing-tool moving pulley 127, a processing-tool moving member 128, and a processing-tool moving guide shaft 129.

The X-axis drive motor 121 is a drive source that is rotatable in both the forward direction and the reverse direction to move the processing-tool operating device 110 that retains the cutting tool 111 and the creasing tool 112, in a direction intersecting the conveyance direction of the sheet 1 (the Y direction). The rotary shaft of the X-axis drive motor 121 is coupled with the deceleration timing pulley 124 from the output timing pulley 122 via the first timing belt 123.

The deceleration timing pulley 124 is in contact with the first processing-tool moving pulley 125 via a gear portion that is molded as a single component. Accordingly, as the X-axis drive motor 121 drives to rotate the deceleration timing pulley 124, the first processing-tool moving pulley 125 rotates via the gear portion.

As illustrated in FIGS. 5 and 6, the first processing-tool moving pulley 125 and the second processing-tool moving pulley 127 as a pair together are coupled by the second timing belt 126. Accordingly, the second timing belt 126 that is wound around the first processing-tool moving pulley 125 and the second processing-tool moving pulley 127 rotates along with rotation of the first processing-tool moving pulley 125.

The processing-tool moving member 128 holds the second timing belt 126 to fix at a given position of the second timing belt 126. Accordingly, as the second timing belt 126 rotates between the first processing-tool moving pulley 125 and the second processing-tool moving pulley 127, the processing-tool moving member 128 also moves according to the direction of rotation of the second timing belt 126. The processing-tool moving guide shaft 129 is inserted through the processing-tool moving member 128. The processing-tool moving guide shaft 129 is disposed extending in the X direction. Both end portions of the processing-tool moving guide shaft 129 are fixed to a housing of the sheet processing apparatus 100. Accordingly, along with rotation of the second timing belt 126, that is, along with rotation of the X-axis drive motor 121, the processing-tool moving member 128 is guided by the processing-tool moving guide shaft 129 to move in the X direction alone. Consequently, as the X-axis drive motor 121 rotates in the forward direction and the reverse direction, the processing-tool operating device 110 that is coupled with and fixed to the processing-tool moving member 128 reciprocally moves in the direction (the X-axis direction) intersecting the conveyance direction of the sheet 1. Accordingly, the sheet processing tools 105 are held to be reciprocally movable in the direction (the X-axis direction) intersecting the conveyance direction of the sheet 1.

Structure of Tool Facing Device 130

Next, a description is given of the configuration of the tool facing device 130, with reference to FIG. 3. The tool facing device 130 includes the first facing roller 131, the second facing roller 132, the first gripping rollers 133 (that is, the first gripping roller 133a and the first gripping roller 133b), and the second gripping rollers 134 (that is, the second gripping roller 134a and the second gripping roller 134b). The first facing roller 131 and the second facing roller 132 are rotary members that rotate in both directions, which are the forward direction and the reverse direction, by a drive source such as an electric motor. The first facing roller 131 and the second facing roller 132 rotate to convey the sheet 1 in synchrony with conveyance of the sheet 1 by the first pair of conveyance rollers 151 and the second pair of conveyance rollers 152. The first facing roller 131 and the second facing roller 132 are also drive rollers. The first gripping rollers 133 and the second gripping rollers 134 are driven rollers that rotate along with rotations of the drive rollers.

Each of the first gripping rollers 133 is pressed (biased) by a biasing member in a negative Z direction so as to be pressed against the first facing roller 131. Each of the second gripping rollers 134 is pressed (biased) by a biasing member in the negative Z direction so as to be pressed against the second facing roller 132. Accordingly, the first facing roller 131 and the first gripping rollers 133 (that is, the first gripping roller 133a and the first gripping roller 133b) grip the sheet 1 while the sheet 1 is being processed. Further, the second facing roller 132 and the second gripping rollers 134 (that is, the second gripping roller 134a and the second gripping roller 134b) also grip the sheet 1 while the sheet 1 is being processed. Note that, in FIG. 3, a part of the second gripping rollers 134 (that is, the second gripping roller 134b) is hidden behind the processing-tool operating device 110, and therefore the second gripping roller 134h is not depicted in FIG. 3.

When the sheet 1 is processed, in addition to the conveyance by the first pair of conveyance rollers 151 and the second pair of conveyance rollers 152, the operation of the sheet 1 is controlled such that the first facing roller 131 and the second facing roller 132, which are drive rollers, rotate in forward and reverse directions to reciprocally convey the sheet 1 during processing and perform sheet processing along the processing path 2 formed in the sheet 1. That is, the tool facing device 130 also functions as a conveying unit that conveys the sheet 1 back and forth in the Y direction. Due to the control of rotation of the tool facing device 130, the sheet 1 is reciprocally conveyed between the cutting tool 111 and the first facing roller 131 and between the creasing tool 112 and the second facing roller 132.

The rotary members such as the pairs of conveyance rollers 150, the first facing roller 131, and the second facing roller 132, and the X-axis drive motor 121 in the present embodiment are assumed to be stepping motors. The rotary members are not limited to stepping motors, and any type of rotating member may be used as long as the above-described operation can be achieved. The first contact-and-separation actuator 115 and the second contact-and-separation actuator 116 according to the present embodiment are assumed to have solenoids, respectively. However, any other type of driving device may be used as long as the above-described operation can be achieved.

In the present embodiment, the sheet processing tool 105 and the processing-tool operating device 110 are moved in the width direction of the sheet 1 by the tool moving device 120. However, the configuration of the sheet processing apparatus according to an embodiment of the present disclosure is not limited to the above-described configuration example. Fax example, a configuration may be used in which an operation of bringing the sheet processing tool 105 into contact with or away from the sheet 1 is achieved by the operation of the tool moving device 120. Alternatively, only the sheet processing tool 105 may be moved by a mechanism capable of moving the sheet processing tool 105 in the width direction of the sheet 1 and a mechanism capable of bringing the sheet processing tool 105 into contact with and away from the sheet 1.

### First Embodiment

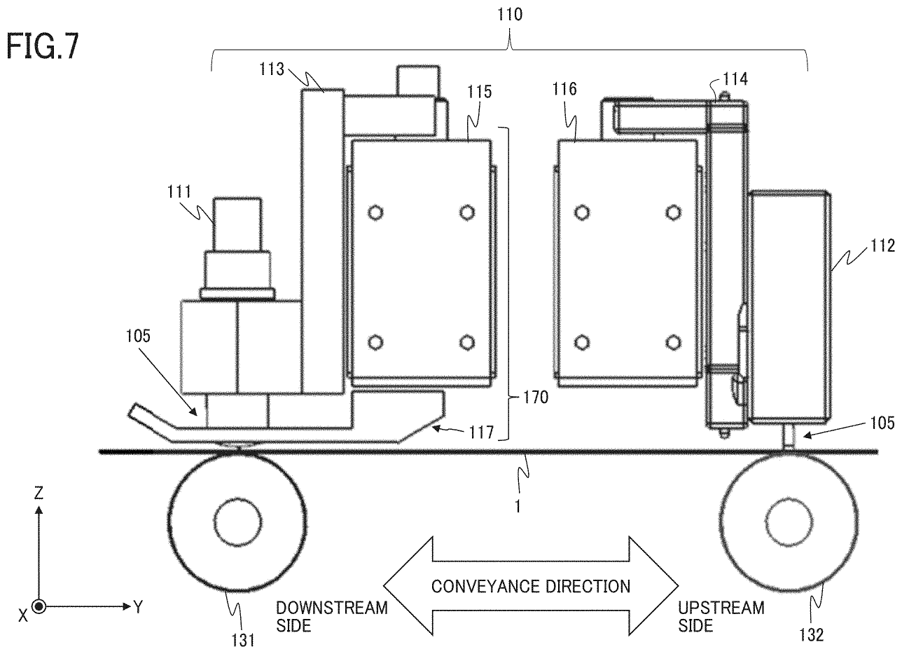

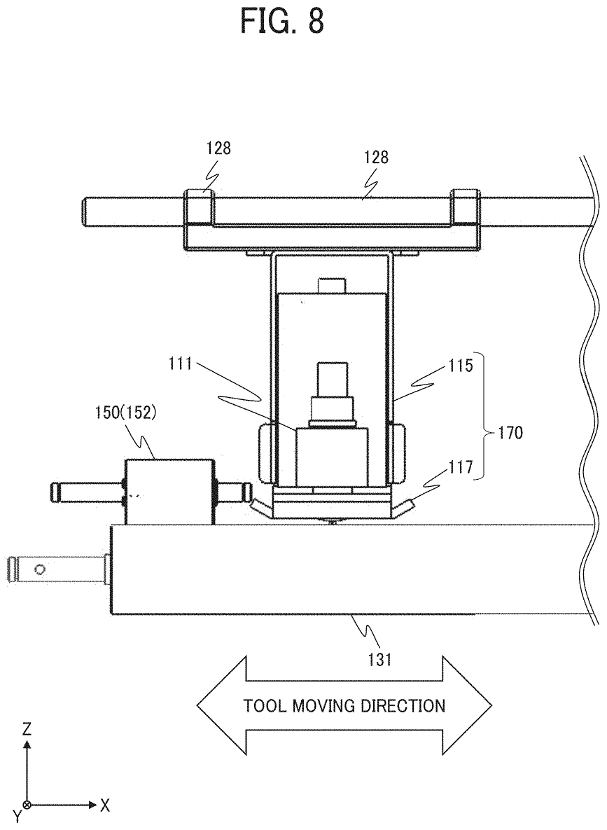

Next, a configuration that is one of the characteristic configurations of the sheet processing apparatus according to the present disclosure and that restricts unintended movement of a processing object during sheet processing is described with reference to the drawings. FIG. 7 is a side view of a main part of the internal structure of the sheet processing apparatus 100 according to a first embodiment of the present disclosure. FIG. 8 is a partial front view of the main part of the internal structure of the sheet processing apparatus 100 according to the first embodiment of the present disclosure.

As illustrated in FIG. 7, the processing-tool operating device 110 according to the present embodiment includes a sheet movement regulator 170. The sheet movement regulator 170 includes a sheet regulating member 117 as a regulating member. The sheet regulating member 117 is configured to perform a predetermined operation by a processing-tool operating device 110 serving as a processing-tool contact-and-separation device. Accordingly, the sheet movement regulator 170 includes the sheet regulating member 117 and the first contact-and-separation actuator 115 acting as a driving source of the sheet regulating member 117. The “predetermined operation” of the sheet regulating member 117 is an operation for regulating an unintended change (including deformation or movement) of the sheet 1 during sheet processing.

The unintended change of the sheet 1 is, for example, as follow. First, a case where the cutting tool 111 performs cutting on the sheet 1 is described below. In this case, the cutting blade included in the cutting tool 111 moves in a direction penetrating the sheet 1 by the press-contact operation, and then moves in a direction separating from the sheet 1 by the separating operation. In this series of operations, when the cutting blade moves in the direction in which the cuffing blade penetrates the sheet 1, the movement of the sheet 1 in the direction in which the sheet 1 is pushed in by the tool facing device 130 (the first facing roller 131) can be restricted, thus preventing a deviation of the processing position of the sheet 1.

On the other hand, when the cutting blade is moved in a direction away from the sheet 1 by the separating operation, the sheet 1 is moved following the moving direction (moved in a direction in which the sheet 1 is lifted with respect to the tool facing device 130). If such movement of the sheet 1 is not regulated, the processing position would deviate when the cutting tool 111 is relatively operated along the processing path 2. For this reason, in the sheet processing apparatus 100 according to the present embodiment, the sheet regulating member 117 serving as a regulating member is disposed in the vicinity of the cutting tool 111 serving as a processing tool and is operated so as to suppress an unintended change of the sheet 1 caused by the operation of the cutting tool 111. In other words, the sheet regulating member 117 regulates the movement of the processing tool by the processing-tool operating device 110 from moving the sheet 1 in the direction (Z direction) different from the conveyance direction of the sheet 1. Thus, the processing accuracy of the sheet 1 can be enhanced.

The sheet regulating member 117 may also be provided for the creasing tool 112. In such a case, the second contact-and-separation actuator 116 that operates the creasing tool 112 operates the sheet regulating member on the creasing tool 112 side. Accordingly, even in the creasing with the creasing tool 112, an unintended change of the sheet 1 can be effectively restrained, thus enhancing the accuracy of the sheet processing.

In FIG. 7, the sheet regulating member 117 is disposed in the vicinity of the cutting tool 111 so as to surround the cutting tool 111. As a matter of course, the sheet regulating member 117 may be disposed in the vicinity of the creasing tool 112 so as to surround the creasing tool 112.

The sheet regulating member 117 has a shape that does not disturb the movement of the cutting tool 111 or the creasing tool 112 as a processing tool when the cutting tool 111 or the creasing tool 112 moves to a position (processing position) where the cutting tool 111 or the creasing tool 112 contacts the sheet 1 to perform sheet processing. During sheet processing, the cutting tool 111 and the creasing tool 112 protrude toward the sheet 1 with respect to the sheet regulating member 117. The sheet regulating member 117 has a configuration in which the sheet regulating member 117 can accommodate the cutting tool 111 or the creasing tool 112 when the cutting tool 111 or the creasing tool 112 is at a position (separated position) where the cutting tool 111 or the creasing tool 112 is separated from the sheet 1. When the cutting tool 111 performs the separating operation to move to the retreat position, the sheet 1 is peeled off from the cutting tool 111 by the sheet regulating member 117.

The sheet regulating member 117 has a guide shape in which an end portion of the sheet regulating member 117 in the conveyance direction (Y direction) of the sheet 1 is inclined to the Z direction. The guide shape is formed at each of an upstream end portion and a downstream end portion in the conveyance direction of the sheet 1. Further, as illustrated in FIG. 8, the sheet regulating member 117 has a guide shape in which an end portion of the sheet regulating member 117 in the moving direction (X direction) of the processing-tool operating device 110 is also inclined to the Z direction. The guide shape is formed at each end portion in the scanning direction of the processing-tool operating device 110. As described above, any of the end portions of the sheet regulating member 117 has a guide shape inclined in a direction away from the sheet 1. Thus, the sheet regulating member 117 does not interfere with the conveyance of the sheet 1 and the scanning of the processing-tool operating device 110. Such a configuration can also prevent the sheet regulating member 117 from being caught by the sheet 1 and damaging the sheet 1.

As already described, the cutting tool 111 and the creasing tool 112 are controlled for selective contact with or separation from the sheet 1. In other words, the cutting tool 111 and the creasing tool 112 move between the processing position and the retreat position in the normal direction of the sheet 1 (that is, the Z direction). On the other hand, the sheet regulating member 117 is disposed so as to surround each of the cutting tool 111 and the creasing tool 112 and has a structure and shape that do not interfere with the movement of the cutting tool 111 and the creasing tool 112 in the Z direction. The sheet regulating member 117 is configured so as not to interfere with the sheet processing operations of the cutting tool 111 and the creasing tool 112 even in its operation.

The sheet regulating member 117 has a configuration capable of performing contact-and-separation control for selectively contacting or separating from the sheet 1 by the first contact-and-separation actuator 115. In other words, the sheet regulating member 117 is also movable between the sheet regulating position and the retreat position in the Z direction by the first contact-and-separation actuator 115 serving as a regulating-member contact-and-separation unit. If the sheet regulating member 117 is also disposed for the creasing tool 112, the second contact-and-separation actuator 116 serving as a regulating-member contact-and-separation unit operates the sheet regulating member 117 on the creasing tool 112 side.

That is, the regulating-member contact-and-separation unit that moves the sheet regulating member 117 may be configured to use a common actuator without being based on a separate actuator such as the first contact-and-separation actuator 115 (second contact-and-separation actuator 116). For example, a DC motor and a cam mechanism may be used to control the contact and separation of the cutting tool 111 and the sheet regulating member 117 and also control the operation of the sheet regulating member 117.

Next, a description is given of the operation of the sheet regulating member 117 interlocked with the operation of each processing tool by the processing-tool operating device 110 during sheet processing. First, the relation of the operation of the sheet regulating member 117 with the contact-and-separating operation of the cutting tool 111 is described with reference to a plurality of drawings. FIGS. 7 and 8 illustrate a state in which the cutting tool 111 is brought to the processing position by the press-contact operation. In the state, the sheet regulating member 117 is placed at a sheet regulating position at which the sheet regulating member 117 approaches the sheet 1 and can regulate the movement of the sheet 1.

As described above, the “processing position” of the sheet regulating member 117 refers to a position at which the cutting tool ill as the first processing tool contacts (presses) the sheet 1 to cut the sheet 1. The “regulating position” refers to a position at which the sheet regulating member 117 approaches the sheet 1 and regulates floating of the sheet 1 due to processing by the cutting tool 111 or movement (deviation) of the sheet 1 due to scanning by the cutting tool 111. The same applies to the relation of the operation of the sheet regulating member 117 with the contact-and-separating Operation of the creasing tool 112. Any of The position of the cutting tool 111 when the cutting tool 111 is not at the “processing position” and the position of the sheet regulating member 117 when the sheet regulating member 117 is not at the “regulating position” corresponds to the “retreat position”.

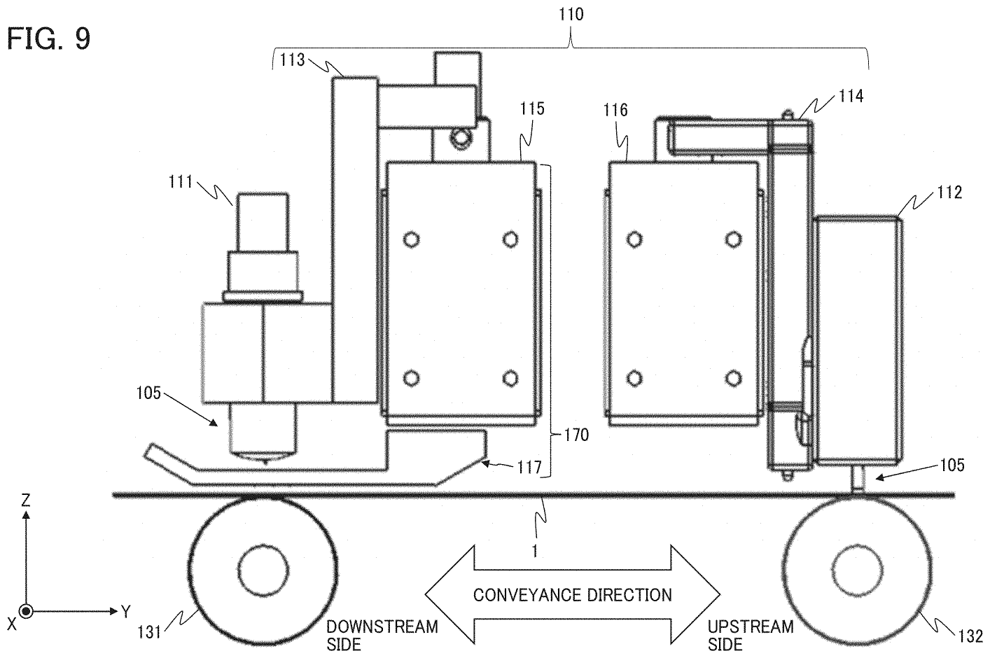

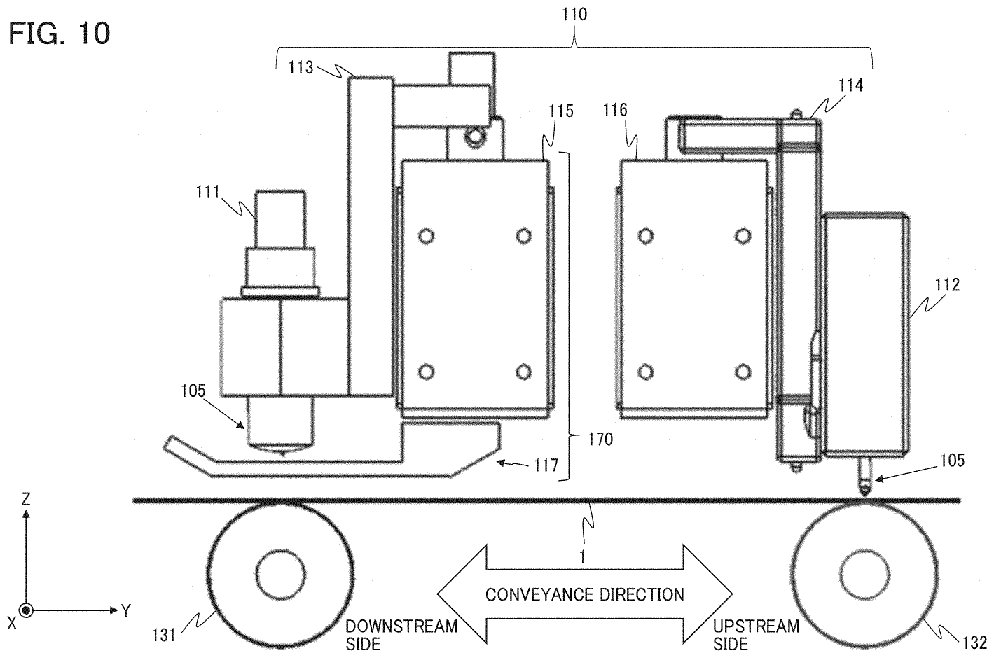

FIG. 9 illustrates a state in which the cutting tool 111 is at the retreat position and the sheet regulating member 117 is at the sheet regulating position. FIG. 10 illustrates a state in which the cutting tool 111 is at the retreat position and the sheet regulating member 117 is also at the retreat position away from the sheet regulating position.

First, when the sheet 1 before processing is carried in and the sheet 1 is received and conveyed to the sheet processing position by the processing-tool operating device 110 including the cutting tool 111, the state illustrated in FIG. 10 is set, in other words, the state is set in which the cutting tool 111 is at the retreat position and the sheet regulating member 117 is at the retreat position.

Subsequently, as a preparation stage for cutting the sheet 1, the sheet regulating member 117 is lowered and moved to the regulating position. Then, as illustrated in FIG. 9, the sheet regulating member 117 is set to the sheet regulating position while the cutting tool 111 is kept at the retreat position. Thus, the posture of the sheet 1 can be regulated.

Thereafter, when the cutting process (cutting process) for the sheet 1 is started, the culling tool 111 is moved to the processing position as illustrated in FIGS. 7 and 8. In this state (sheet processing state), the cutting tool 111 is at a position at which the cutting tool 111 is pressed against the sheet 1 to cut the sheet 1. The sheet 1 and the cutting tool 111 are relatively moved with the cutting tool 111 maintained at the position, to perform cutting. At this time, since a force due to, e.g., friction with the cutting tool 111 acts on the sheet 1, the sheet regulating member 117 is placed at the regulating position for regulating the movement of the sheet 1 so that the sheet 1 does not move in an unintended direction.

That is, in the cutting process, since the cutting tool 111 reciprocates between the processing position and the retreat position according to the shape of a figure to be processed (processing path 2), it is necessary to regulate the movement of the sheet 1 due to the influence of the movement of the cutting tool 111. Therefore, in the control method according to the present embodiment, the sheet processing is performed while controlling the sheet regulating member 117 to be maintained at the sheet regulating position in a state in which the cutting tool 111 is moved to the processing position as illustrated in FIGS. 7 and 8 and the sheet regulating member 117 to be held at the regulating position in a state in which the cutting tool 111 is moved to the retreat position as illustrated in FIG. 9.

When the sheet processing is completed, as illustrated in FIG. 10, the cutting tool 111 is set to the retreat position, the sheet regulating member 117 is also set to the retreat position, and the sheet 1 is ejected and conveyed.

In the sheet processing apparatus 100 according to the present embodiment, sheet processing can be performed in any direction within a plane formed by the sheet conveyance direction and a direction orthogonal to the sheet conveyance direction. Accordingly, the sheet regulating member 117 needs to be configured not to interfere with the sheet 1 conveyed for processing in a state where the sheet regulating member 117 is at the sheet regulating position. Therefore, the surface of the sheet regulating member 117 in contact with the sheet 1 preferably has a smooth surface. As described above, the sheet regulating member 117 has a guide shape capable of guiding the sheet 1 to any of the upstream side and the downstream side in the sheet conveyance direction and the left end side and the right end side in the sheet width direction.

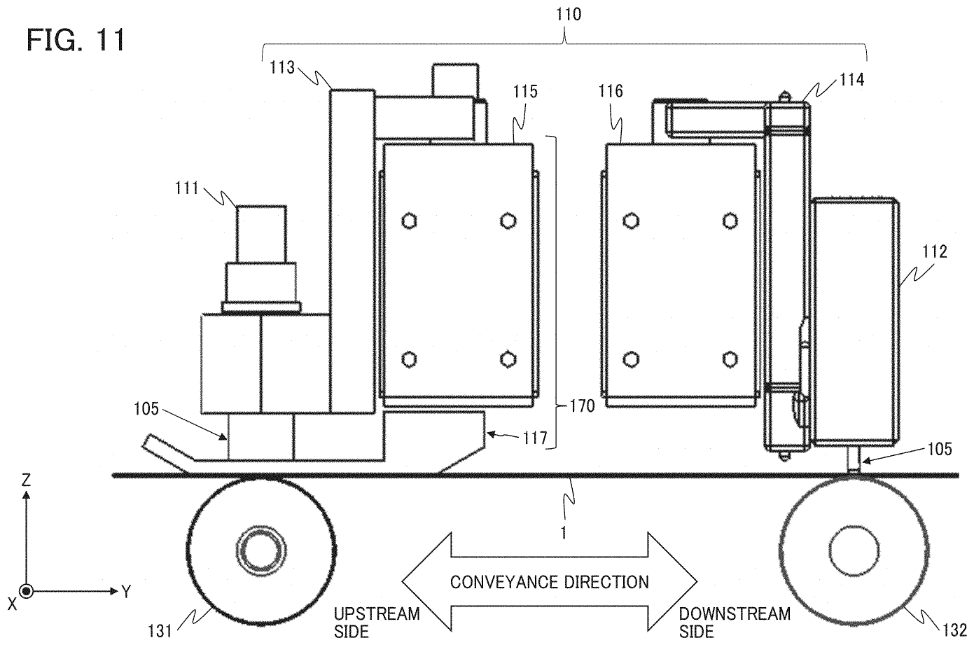

In the example described above, the sheet regulating member 117 is in a state in which a gap is formed between the sheet regulating member 117 and the sheet 1 at the regulating position. However, as illustrated in FIG. 11, the sheet regulating member 117 may contact and press the sheet 1 at the regulating position. If the sheet regulating members 117 corresponding to the plurality of processing tools (for example, the cutting tool 111 and the creasing tool 112) controlled by the processing-tool operating device 110 are provided and one processing tool is at the processing position and the other processing tool is at the separated position, both the sheet regulating member 117 on the one processing tool side and the sheet regulating member 117 on the other processing tool side may be at the regulating positions. Thus, the posture of the sheet 1 during processing is further stabilized.

### Second Embodiment

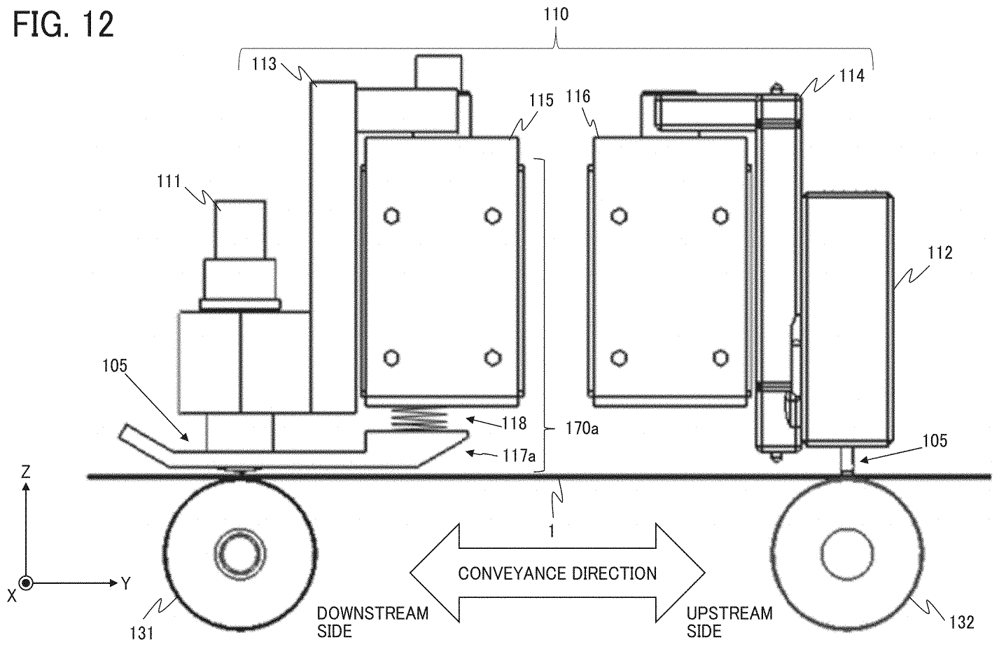

Next, a description is given of a sheet processing apparatus according to a second embodiment of the present disclosure. FIG. 12 is a side view of a main part of the internal structure of the sheet processing apparatus 100 according to the second embodiment. As illustrated in FIG. 12, the processing-tool operating device 110 according to the present embodiment includes a sheet movement regulator 170a. A sheet regulating member 117a serving as a regulating member provided in the sheet movement regulator 170a is biased toward the sheet 1 by a spring 118 serving as a biasing member, and is configured to regulate an unintended change (including deformation or movement) of the sheet 1 during sheet processing. The sheet regulating member 117a also performs a predetermined operation by the processing-tool operating device 110 as a processing-tool contact-and-separation device.

One end portion of the spring 118 is fixed to, for example, the first contact-and-separation actuator 115, and the other end portion of the spring 118 is fixed to the sheet regulating member 117a. The spring 118 biases the sheet regulating member 117a against the sheet 1 when the sheet regulating member 117a is moved to the regulating position. Thus, when the sheet regulating member 117a is placed at the regulating position, the movement of the sheet 1 can be more reliably regulated.

The pressing force acting when the sheet regulating member 117 comes into contact with the sheet 1 is adjusted by the spring 118 in accordance with the thickness dimension of the sheet 1. Accordingly, the pressing force can be adjusted to a different regulating force in accordance with the type of the sheet 1. Thus, damage on the sheet 1 can be sufficiently restrained while being reduced.

### Third Embodiment

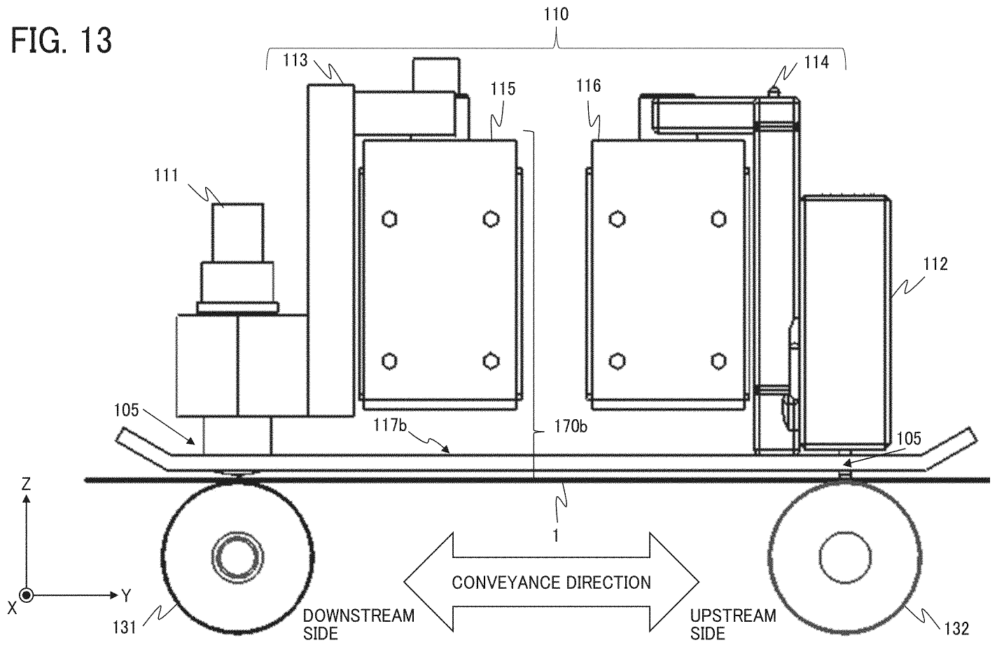

Next, a description is given of a sheet processing apparatus according to a third embodiment of the present disclosure. FIG. 13 is a side view of a main part of the internal structure of the sheet processing apparatus according to the third embodiment. As illustrated in FIG. 13, the processing-tool operating device 110 according to the present embodiment includes a sheet movement regulator 170b. The sheet regulating member 117b as a regulating member provided in the sheet movement regulator 170b is formed of an integrated body that can regulate the sheet 1 on both the cutting tool 111 side and the creasing tool 112 side.

That is, according to the sheet regulating member 117b, the member for restraining an unintended movement of the sheet 1 with respect to the plurality of processing tools can be configured by a common component, thus allowing the configuration for restraining the movement of the sheet 1 to be simplified.

### Fourth Embodiment

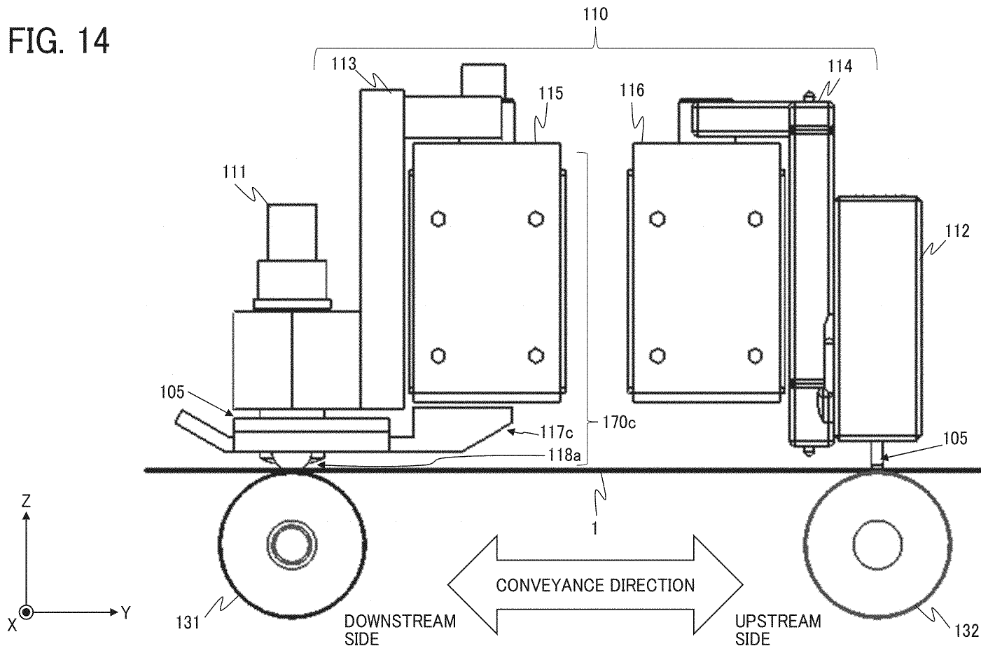

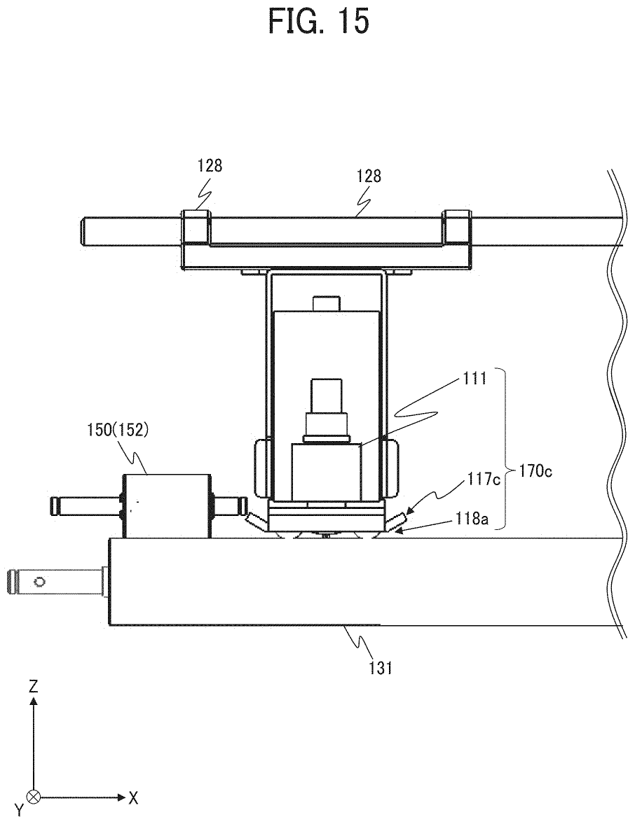

Next, a description is given of a sheet processing apparatus according to a fourth embodiment of the present disclosure. FIG. 14 is a side view of a main part of the internal structure of the sheet processing apparatus 100 according to the fourth embodiment. FIG. 15 is a partial front view of a main part of the internal structure of the sheet processing apparatus 100 according to the fourth embodiment.

As illustrated in FIGS. 14 and 15, the processing-tool operating device 110 according to the present embodiment includes a sheet movement regulator 170c. The sheet movement regulator 170c includes a contact member 118a on the sheet regulating member 117c as a regulating member. The contact member 118a is to come into contact with the sheet 1. The contact member 118a corresponds to a portion facing the sheet 1. The tip of the contact member 118a has a curved (spherical) contact surface with the sheet 1 so as to be in point contact with the sheet 1. In the sheet regulating member 117c, the contact member 118a constituting the contact surface with the sheet 1 may be constituted by a spherical member. In such a case, the contact member 118a as the spherical member may be a separate body independent of the sheet regulating member 117c and may be relatively rotatable held with respect to the sheet 1. Accordingly, the sheet 1 can be processed by relatively moving the sheet 1 while the sheet regulating member 117c remains at the regulating position, thus allowing the sheet 1 to be pressed with a small pressing force. Such a configuration can also prevent he sheet 1 from being damaged by the sheet regulating member 117c.

As illustrated in FIG. 15, the spherical members may be arranged so as to sandwich the cutting tool 111 in the movement direction of the cutting tool 111. Since both sides of the cutting tool 111 can be pressed by the plurality of contact members 118a, floating or the like of the sheet 1 can be reliably restrained.

### Fifth Embodiment

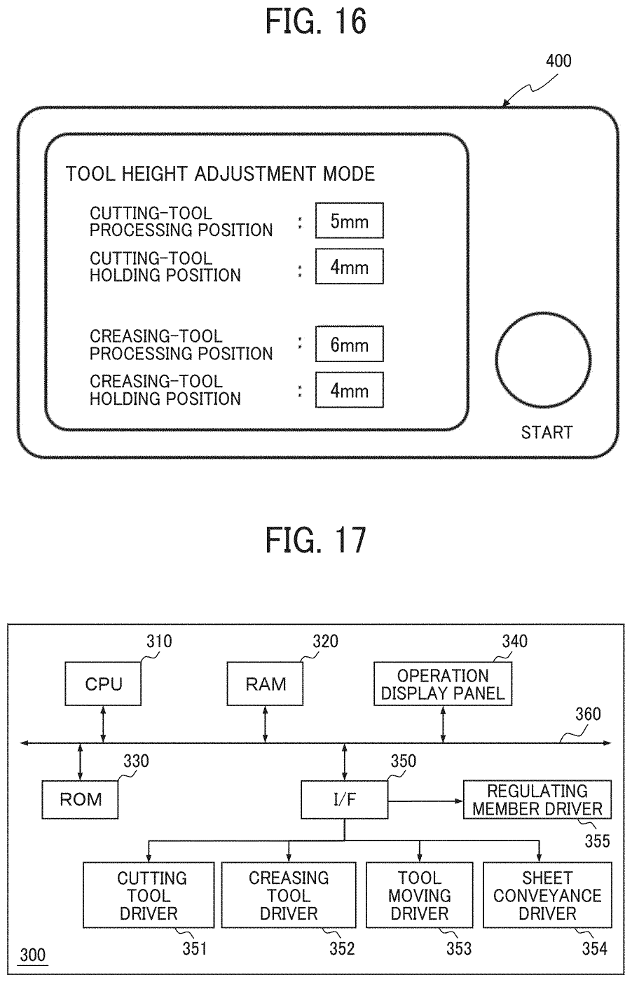

Next, a description is given of a sheet processing apparatus according to a fifth embodiment of the present disclosure. The sheet processing apparatus 100 according to the present embodiment displays an operation screen 400 as illustrated in FIG. 16 on an operation display panel 340 as an operation device described later. The operation screen 400 is a screen for setting processing conditions in various tools (the cutting tool 111 as the cutting tool and the creasing tool 112 as the creasing tool) used for sheet processing.

The processing conditions include, for example, in the case of cutting processing, conditions for designating the degree of cutting, such as “full-cut processing” for completely cutting out the sheet 1 or “half-cut processing” for leaving the sheet 1, and can be set according to the size of a “cutting tool processing position”. Setting the “cutting tool processing position” based on the sheet thickness determined according to the type of the sheet 1 allows a plurality of cutting processes as described above to be arbitrarily selected.

The processing conditions also include conditions for creasing processing. For example, the degree of the depth of a crease formed on the sheet 1 can be set by the dimension of the “creasing-tool processing position”. Setting the “creasing-tool processing position” based on the sheet thickness determined according to the type of the sheet 1 allows a plurality of cutting processes as described above to be arbitrarily selected.

As described above, the setting values set via the operation screen 400 are held by a processing-condition setting unit 317, which will be described later, and are used for controlling the sheet processing operation by the controller 311. A user can arbitrarily input the adjustment value of the processing position and the adjustment value of the regulating position by the sheet regulating member 117 via the operation screen 400. Accordingly, the processing positions of the cutting tool 111 and the creasing tool 112 and the regulating position of the sheet regulating member 117 can be arbitrarily set based on the input values. Note that specific dimensions may be automatically set by inputting information indicating attributes of the sheet 1, such as the type and thickness of the sheet 1, on the operation screen 400 and selecting the degree of processing (whether full-cut processing or half-cut processing, or whether to crease deeper or shallower) for the attribute information of the sheet 1. Thus, sheet processing can be performed under conditions suitable for the sheet 1.

Control Configuration of Sheet Processing Apparatus 100.

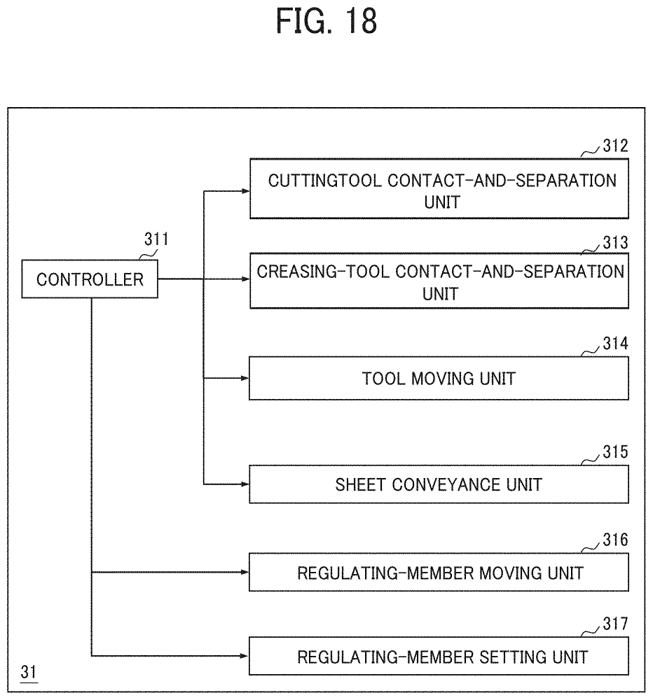

Next, a description is given of the control configuration of the sheet processing apparatus 100 according to the present embodiment of this disclosure, with reference to FIGS. 17 and 18. FIG. 17 is a block diagram illustrating a hardware configuration of the control system of the sheet processing apparatus 100. FIG. 18 is a block diagram illustrating a functional configuration of the control system of the sheet processing apparatus 100.

As illustrated in FIG. 17, the sheet processing apparatus 100 includes the control device 300. The control device 300 has the same configuration as generally known information processing devices. That is, in the control device 300 according to the present embodiment of this disclosure, a central processing unit (CPU) 310, a random access memory (RAM) 320, a read only memory (ROM) 330, an operation display panel 340, and an interface (IT) 350 are connected via a bus 360. A cutting tool driver 351, a creasing tool driver 352, a tool moving driver 353, a sheet conveyance driver 354, and a regulating member driver 355 are connected to the I/F 350.

The CPU 310 is a calculation unit and controls the operation of the entire information processing device. The RAM 320 is a volatile memory capable of high-speed reading and writing of information. The RAM 320 is used as a work area when the CPU 310 processes information. The ROM 330 is a read-only non-volatile memory to store firmware, control programs, and the like. The operation display panel 340 is provided with a display screen that displays information to notify a user of the operation status of the sheet processing apparatus 100, for example. The operation display panel 340 also provides an input interface via which a user inputs a set value to be used for the control.

The I/F 350 transmits a control signal generated as a result of calculation of the CPU 310, to a specified driver, so that the driver causes a corresponding unit to perform each designated function. The cutting tool driver 351 controls the contact and separation operations in which the cutting tool 111 selectively contacts to and separates from the sheet 1. The creasing tool driver 352 controls the contact and separating operations in which the creasing tool 112 selectively contacts to and separates from the sheet 1. The tool moving driver 353 controls rotational movement of the X-axis drive motor 121 in the forward and reverse directions. The sheet conveyance driver 354 controls respective rotational operations of the first facing roller 131 and the second facing roller 132 and rotational operations of the pairs of conveyance rollers 150.

The regulating member driver 355 performs control so as to maintain the sheet regulating member 117 at the retreat position or the regulating position.

Functional Configuration of Sheet Processing Apparatus 100.

In the hardware configuration described above, the CPU 310 performs calculation according to the program stored in the ROM 330, thereby constructing a software controller. A combination of the software controller thus constructed and the hardware constructs functional blocks that implement functions of the sheet processing apparatus 100 according to the present embodiment is formed.

As illustrated in FIG. 18, a control unit 31 is achieved by the control device 300 of the sheet processing apparatus 100 and includes a controller 311 that controls the whole operations of the sheet processing apparatus 100, a cutting-tool contact-and-separation unit 312, a creasing-tool contact-and-separation unit 313, a tool moving unit 314, a sheet moving unit 315, a regulating-member moving unit 316, and the processing-condition setting unit 317.

The tool moving unit 314 controls the direction of movement in the X-axis direction, the moving amount, the moving speed, and timings of start and stop of movement of the processing tool 105. The tool moving unit 314 notifies the controller 311 of the operation state of the processing-tool operating device 110 and the operation state of the tool moving device 120.

The sheet moving unit 315 controls the sheet 1 along the Y-axis (the Y direction), specifically, the moving direction (the conveyance direction), the moving amount, the moving speed, and timings of start and stop of movements of the sheet 1 along the Y-axis (the Y direction). The sheet moving unit 315 notifies the controller 311 of the operation states of the tool facing device 130 and the pairs of conveyance roller 150.

The cutting-tool contact-and-separation unit 31 causes the cutting tool 111 to contact, press, or separate from the sheet 1 at a given timing. The creasing-tool contact-and-separation unit 313 causes the creasing tool 112 to contact, press, or separate from the sheet 1 at a given timing.

The regulating-member moving unit 316 appropriately performs control to move the sheet regulating member 117 to the retreat position or the regulating position according to the movement of the cutting tool 111 or the creasing tool 112 to the processing position.

The processing-condition setting unit 317 stores the processing condition set on the operation screen 400 illustrated in FIG. 16, and holds the setting of the operation condition when the controller 311 controls the sheet processing process. Note that the processing condition is specified by information that can be input on the operation screen 400, and for example, specifies whether the culling processing is full cutting or half cutting. In the case of the creasing processing, the depth of the crease corresponds to the processing condition. Thus, the strength of the crease can be set.

The processing condition may include a sheet condition for designating the type the sheet 1. The sheet condition is, for example, information capable of specifying the thickness of the sheet 1 to be processed, and includes the type of the sheet 1 and the like.

The processing condition may include the dimension of the gap between the sheet regulating member 117 and the sheet 1 at the regulating position.

The control unit 31 including a control program executed by the CPU 310 configures the above-described function units, so that the function units execute the control operations. By performing these control operations, the cutting tool 111 and the creasing tool 112 are moved while conveying the sheet 1, so as to selectively perform the contact and separation operations. While a given trajectory in the two-dimensional area is drawn on the sheet 1 by performing the contact and separation operations, sheet processing can be performed in which the crease process is performed to the sheet 1 at a desired position or positions and cutting is performed on the sheet 1 into a desired shape.

Further, the operation of the sheet regulating member 117 is controlled by the controller 31 according to the control program executed by the CPU 310 at the timing interlocked with the execution of the sheet processing. Thus, an unintended change of the sheet 1 during sheet processing can be effectively restrained.

The first facing roller 131 that includes a tool opposing face to face the culling tool 111 and the second facing roller 132 that includes the tool opposing face to face the creasing tool 112 are rollers including elastic bodies represented by silicon rubber and ethylene propylene (EP) rubber.

Here, a detailed description is given of the operations of the sheet processing apparatus 100. When sheet processing (first processing) is performed to the sheet 1 in the direction orthogonal to the conveyance direction of the sheet 1, the first facing roller 131 and the second facing roller 132 are held not to rotate. When sheet processing (second processing) is performed to the sheet 1 in a direction other than the direction orthogonal to the conveyance direction of the sheet 1, the first facing roller 131 and the second facing roller 132 rotate in the conveyance direction of the sheet 1. By performing the operation controls as described above, the positions (portions) of the opposing faces of the first facing roller 131 and the second facing roller 132, at which the sheet processing tools 105 are received, may be changed according to the conveyance direction of the sheet 1. As a result, when sheet processing is performed to the sheet 1 in the width direction while changing the positions of opposing faces of the first facing roller 131 and the second facing roller 132, the opposing faces are held not to move so that stable processing is performed.

The sheet movement regulator 170 is moved to the regulating position or the retreat position according to the state of the sheet processing on the sheet 1. Such a configuration can prevent the sheet 1 from being lifted or warped during the sheet processing, thus preventing the processing accuracy from being lowered.

Detailed Description of Embodiment of Creasing Tool 112.

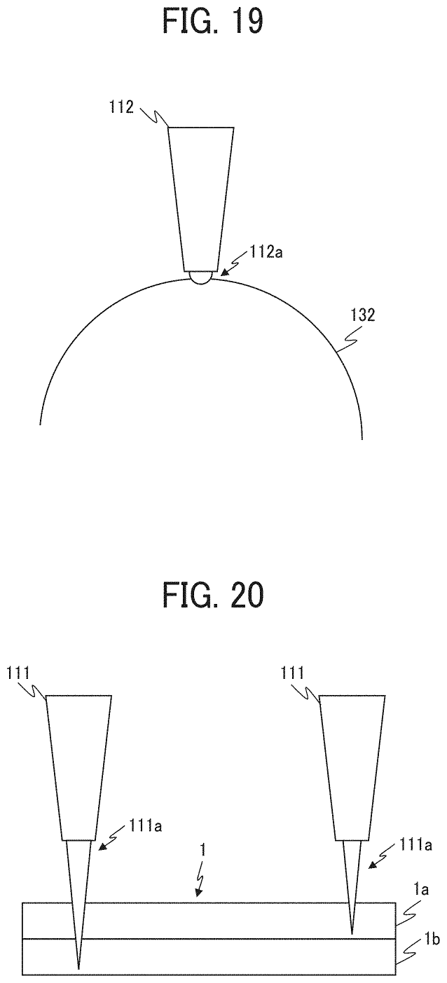

Next, a description is given of the detailed configuration of the creasing tool 112, with reference to FIG. 19. FIG. 19 is an enlarged side view illustrating the tip of the creasing tool 112 of the sheet processing apparatus 100. A tip member 112a is attached to the tip of the creasing tool 112. The tip member 112a is a spherical member and is held at the tip of the creasing tool 112. The tip member 112a contacts and presses the second facing roller 132. The surface of the second facing roller 132 has elasticity. Therefore, when the second facing roller 132 is pressed by the tip member 112a, the surface of the second facing roller 132 is recessed.

While the sheet 1 is held between the tip member 112a of the creasing tool 112 and the second facing roller 132, the creasing tool 112 moves to the sheet 1 relatively in the two-dimensional direction. By so doing, the crease process providing the trajectory including given free-form curves is performed to the sheet 1. In the crease process, the tip member 112a moves with low friction in accordance with the relative moving direction of the sheet 1, so that the friction of movement of the creasing tool 112 is reduced when the sheet processing (the crease process) is performed by the creasing tool 112.

Note that the tip member 112a is not limited to a member having a spherical surface but may be a spherical shaped member such as the tip of a ballpoint pen and freely rotatable in given directions. In this case, since the tip member 112a rotates in accordance with the relative moving direction of the sheet 1 when the crease process is performed to the sheet 1, the creasing tool 112 moves with lower friction. Accordingly, in a case in which the tip member 112a is formed of a ball-shaped member, the friction of movement of the creasing tool 112 generated when the crease process is performed by the creasing tool 112 is further reduced.

Further, a pencil or a pen tool such as a ballpoint pen using ink may be used as the tip member 112a. In this case, in the crease process using the creasing tool 112, while moving the tip member 112a of the creasing tool 112 in accordance with the relative moving direction of the sheet 1, the creasing tool 112 draws (forms) an image including free-form curves or visible lines such as ruled lines on the sheet 1 with a given trajectory.

Detailed Embodiment of Cutting Tool 111

Next, a detailed configuration of cutting tools Iii is described with reference to FIG. 20. FIG. 20 is an enlarged side view of tip portions of the cutting tools 111. A cutter blade fila is held at the tip of each cutting tool 111. The cutter blade 111a, is held so that the amount of protrusion may be changed. The cutting tool contact-and-separation unit 312 controls the amount of protrusion of the cutter blade 111a in the thickness direction of the sheet 1. In other words, the cutting tool 111 cuts the sheet 1 in the thickness direction of the sheet 1. For example, when the sheet 1 has layers including a releasable seal layer 1a and a mount layer 1b, in a case in which the tip of the cutter blade 111a of the cutting tool 111 is protruded by the amount corresponding to the thickness of the releasable seal layer 1a, the cutting tool 111 cuts the releasable seal layer 1a alone. In other words, the cutting tool 111 cuts a part of the sheet 1 in the thickness direction of the sheet 1.

Further, in a case in which the tip of the cutter blade 111a of the cutting tool 111 is protruded by the amount corresponding to the sum of the thickness of the releasable seal layer 1a and the thickness of the mount layer 1b, the cutting tool 111 cuts the sheet 1.

In addition, the amount of protrusion of the tip of the cutter blade 111a is controlled intermittently between the amount corresponding to the thickness of the releasable seal layer 1a and the amount corresponding to the sum of the thickness of the releasable seal layer 1a and the thickness of the mount layer 1b, so as to provide a cutting portion and a non-cutting portion intermittently to the sheet 1. That is, the cutting tool 111 provides a cutting portion and a non-cutting portion intermittently to the sheet 1 in the thickness direction of the sheet 1.

Accordingly, when the cutting tool 111 is used when performing sheet processing to the sheet 1, while the cutter blade 111a moves in accordance with the relative moving direction of the sheet 1, the cutting tool 111 performs half cutting or through cutting, including free-form curves with a given trajectory, and perforation.

Embodiment of Image Forming System.

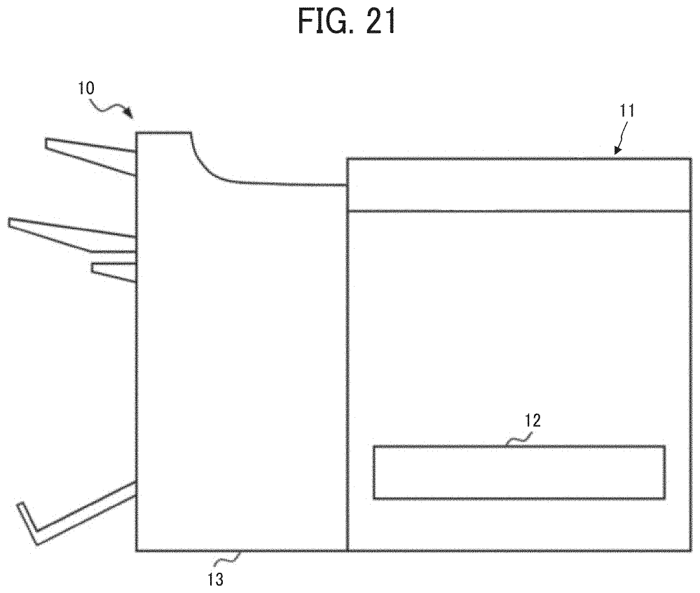

Next, a description is given of an image forming system according to an embodiment of this disclosure, with reference to FIG. 21. FIG. 14 is a side view illustrating the external appearance of an image forming system 10 according to an embodiment of the present disclosure. The sheet processing apparatus 100 described above is applicable as a stand-alone apparatus but may be included in the image forming system 10.

The image forming system 10 includes an image forming apparatus 11 and a post-processing device 13. The image forming apparatus 11 includes a media feeding device 12. The image forming apparatus 11 forms a given image on a sheet 1 fed from the media feeding device 12 and conveys the sheet 1 toward the post-processing device 13. Note that the image forming apparatus 11 is an apparatus that attaches material (such as liquid ink and toner) to form an image onto the sheet 1 that functions as a recording medium and that relates to, for example, electrophotographic printing, inkjet printing, and screen printing.

In a case in which the sheet processing apparatus 100 is provided in the post-processing device 13, after the image forming apparatus 11 forms an image on the sheet 1, the sheet processing apparatus 100 performs the first processing and the second processing, as described above, to convey the processed sheet 1.

Accordingly, the image forming system 10 according to the present embodiment can accurately perform the sheet processing on the sheet 1 on which an arbitrary image is formed along the predetermined processing path 2.

The present disclosure is not limited to specific embodiments described above, and numerous additional modifications and variations are possible in light of the teachings within the technical scope of the appended claims. It is therefore to be understood that, the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

1. A sheet processing apparatus, comprising:
a conveyor configured to convey a sheet;
a processing tool configured to process the sheet;
a processing-tool contact-and-separation device configured to bring the processing tool into contact with the sheet and separate the processing tool from the sheet;
a processing-tool moving device configured to move the processing tool in an intersecting direction intersecting a conveyance direction of the sheet; and
a processing-tool facing device configured to face the processing tool with the sheet interposed between the processing-tool facing device and the processing tool,
the processing-tool contact-and-separation device including a regulating member configured to regulate movement of the sheet in a different direction from both the conveyance direction and the intersecting direction.

2. The sheet processing apparatus according to claim 1,
wherein the processing tool is configured to protrude toward the regulating member when the processing tool comes into contact with the sheet.

3. The sheet processing apparatus according to claim 1,
wherein the regulating member is at a regulating position at which the regulating member regulates the movement of the sheet, when the processing tool processes the sheet.

4. The sheet processing apparatus according to claim 3,
wherein the regulating member is at the regulating position when the processing tool contacts the sheet to process the sheet and when the processing tool separates from the sheet after the processing.

5. The sheet processing apparatus according to claim 1,
wherein a portion of the regulating member configured to face the sheet has a spherical surface.

6. The sheet processing apparatus according to claim 1,
wherein the regulating member includes a spherical member configured to face the sheet.

7. The sheet processing apparatus according to claim 1,
wherein the regulating member and another regulating member are disposed on both sides of the processing tool in a moving direction of the processing tool.

8. The sheet processing apparatus according to claim 1,
wherein the processing-tool moving device includes a biasing member configured to bias the regulating member toward the sheet.

9. The sheet processing apparatus according to claim 1,
wherein the regulating member has a guide shape in which each of both end portions of the regulating member in the conveyance direction is inclined in a direction away from the sheet.

10. The sheet processing apparatus according to claim 1,
wherein the regulating member has a guide shape in which each of both end portions in the intersecting direction, which is a moving direction of the processing tool, is inclined in a direction away from the sheet.

11. The sheet processing apparatus according to claim 1, further comprising an operation device configured to set a processing condition on the sheet,
wherein the processing-tool contact-and-separation device and the processing-tool moving device are configured to perform a sheet processing operation based on the processing condition.

12. The sheet processing apparatus according to claim 11,
wherein the processing condition includes a condition for designating a degree of cutting in a cutting process on the sheet.

13. The sheet processing apparatus according to claim 11,
wherein the processing condition includes a condition for designating a degree of a depth of a streak in a creasing process on the sheet.

14. The sheet processing apparatus according to claim 11,
wherein the processing condition includes information indicating an attribute of the sheet.

15. The sheet processing apparatus according to claim 1,
wherein the different direction is a direction in which the sheet moves in response to a contact operation or a separating operation of the processing tool when the processing tool processes the sheet.

16. The sheet processing apparatus according to claim 1,
wherein the processing-tool contact-and-separation device is configured to control a position of the regulating member with respect to the sheet in the different direction.

17. The sheet processing apparatus according to claim 1, further comprising an operation device configured to set an operation condition of the processing-tool moving device,
wherein the processing tool is configured to set a processing position for the sheet in accordance with the operation condition, and
wherein the regulating member is configured to set a regulating position for the sheet in accordance with the operation condition.

18. An image forming system, comprising:
an image forming apparatus configured to form an image; and
the sheet processing apparatus according to claim 1 configured to process a sheet on which the image is formed.
